(19) United States
(12) Patent Application Publication
(10) Pub. No.: US 2013/0016181 A1
(43) Pub. Date: Jan. 17, 2013

(54) SYSTEM AND METHOD FOR CAPTURING AND DISPLAYING CINEMA QUALITY PANORAMIC IMAGES

(71) Applicant: Max Penner, Van Nuys, CA (US)

(72) Inventor: Max Penner, Van Nuys, CA (US)

(73) Assignee: Social Animal Inc., Seattle, WA (US)

(21) Appl. No.: 13/638,263

(22) PCT Filed: Jun. 8, 2010
(86) PCT No.: PCT/US10/37740

§ 371 Date: Sep. 28, 2012

Related U.S. Application Data
(60) Provisional application No. 61/318,958, filed on Mar. 30, 2010.

(51) Int. Cl. H04N 7/00

(52) U.S. Cl. 348/38; 348/E07.001

(57) ABSTRACT

A system and method for capturing and displaying seamless cinema-quality 360° panoramic photographic and video images is described. In one embodiment, the panoramic imaging system comprises an image capture unit, a computing unit, a cooling unit, and a panoramic image display unit. The image capture unit includes a panoramic camera assembly which comprises a plurality of cameras evenly distributed upon a base plate about a circle of radius Riens. Each camera has its lens pointed at and aligned with a reflecting mirror positioned at a predetermined angle with respect to the vertical. The reflecting mirrors are arranged about a cylindrical support and are affixed to a top plate. The panoramic camera assembly acquires a plurality of images which are wrapped to form a 360° panoramic image. A specially configured Social Animals Flash player allows a user to view, play, manipulate, and click on the processed 360° image file.

### BACKGROUND OF THE INVENTION

I. Field of the Invention

This invention relates generally to a panoramic capture and display system. In particular, the present invention relates to a system and method for the acquisition and display of seamless cinema-quality 360° panoramic photographic and video images. The invention also relates to the use of the panoramic imaging system in the production of interactive, user-controllable 360° panoramic image files.

II. Background of the Related Art

Conventional imaging systems have been limited to the capture and display of two-dimensional images. Their presence is ubiquitous throughout society in the form of photographic images, billboards, two-dimensional video projectors, and flat-screen televisions. Improvements in imaging capabilities require one to think outside the box and devise innovative image acquisition and display systems which would permit a viewer to, for example, acquire and observe images in three dimensions, experience and interact with a virtual environment, or to acquire, observe, and manipulate panoramic views.

Well-known prior art imaging systems generally fall into three categories: pan-tilt-zoom (PTZ) cameras, camera arrays, and mirror-based omni-directional cameras. As the name suggests, PTZ cameras are capable of panning in different directions while tilting and zooming in/out to obtain a desired field of view (FOV). However, the FOV of PTZ cameras is typically fairly limited and repeated panning and zooming is necessary to obtain an image of the desired object with the requisite detail. PTZ cameras also tend to be limited by the slow response time of the camera's motorized controls. Camera arrays can provide an expanded FOV, but are typically limited to linear arrangements which expand the viewing area in one or two directions.

Mirror-based omnidirectional cameras offer considerable potential for imaging in multiple directions and for the production of three-dimensional images. Through the use of a plurality of strategically placed cameras and mirrors, images can be obtained from angular spreads of up to 360° about a central location, stitched together, and presented as panoramic images. This technology has led, inter alia, to the development of a user-controllable virtual reality in which a user can navigate through a plurality of stitched images to observe a panoramic scene which shows how the scene might appear if the user were actually at the imaged location. These innovative developments in imaging technology have led to some unique uses of image capture and display. Some examples include use as omni-directional cameras for videoconferencing, display of panoramic motion pictures, and as 360° video cameras for security systems.

Despite the continual improvement in the imaging equipment, image processing technology, and display capabilities, the development of 360° panoramic imaging continues to the present day. There therefore exists a continuing need in the art for the development of high-quality and low cost panoramic imaging and user-friendly display capabilities.

### SUMMARY OF THE INVENTION

In view of the above-described problems, needs, and goals, in one embodiment of the present invention a system and method for capturing and displaying cinema-quality 360° panoramic images is disclosed. In an exemplary embodiment, the imaging system comprises an image capture unit, a plurality of computing units, a cooling unit, and an image display unit. The imaging system is capable of creating and display 360° panoramic photographic images and video which are of cinema quality, gapless, and with minimal warping or distortion. An additional exemplary embodiment of the present invention relates to a method of capturing and displaying panoramic images.

In one embodiment, the apparatus for capturing and displaying panoramic images comprises a panoramic camera assembly, a plurality of computing units, and a panoramic image display unit. The panoramic camera assembly comprises a base plate and a plurality of cameras whose lens are pointed along a vertical axis and are evenly distributed on the base plate about a circle of radius Riens. Also provided as part of the panoramic camera assembly is a cylindrical support located within the center of the base plate, a plurality of reflecting mirrors, and a top plate. Each of the plurality of reflecting mirrors is aligned with a corresponding camera and is positioned at a predetermined angle with respect to the vertical axis. In a preferred embodiment a total of nine cameras distributed 40° apart about a circle of radius Riens=8.5 inches are provided. Accounting for overlap between the field of view of each camera, a typical angular spread acquired by the plurality of cameras may be up to 405°. An example of a typical camera used is a SI-2k Mini digital cinema camera. The reflecting mirrors are preferably arranged at a predetermined angle of 45° with respect to the vertical axis of the camera lens.

In an exemplary embodiment, a single computing unit is coupled to each individual camera provided on the panoramic camera assembly. Each computing unit includes an acquisition unit configured to receive image data from the panoramic camera assembly, a storage unit configured to store image data acquired by the acquisition unit, and a post-process unit configured to process the image data into a viewable format. An example of an acceptable computing unit is an APPLE MACBOOK PRO® laptop computer. The acquisition unit may be, for example, an Ethernet port present on the computing unit. In one embodiment the viewable format consists of a linear sequence of images which is wrapped to form a 360° panoramic image. The viewable format itself is accessible using a Social Animals 360° Flash player. The image provided is a continuous, seamless, and gapless cinema-quality 360° image with substantially no warping or distortion. In still another embodiment the computing units are contained within a cooling unit which regulates the system temperature and permits continuous and safe operation.

In yet another embodiment a method of capturing and displaying panoramic images is provided. The method involves capturing image data from a plurality of images which together form a 360° panoramic view, transmitting the image data to an acquisition unit, storing the image data on a storage unit, processing the image data into an imaging format capable of being viewed by a user, outputting the images to a panoramic image display unit, and processing the image data into a 360° user-controllable image file. In some embodiments the image data is captures using a plurality of image capture units which may be, for example, SI-22k Mini digital cinema cameras. In a preferred embodiment the acquisition unit is an Ethernet port and the image data is processed using at least one APPLE MACBOOK PRO® laptop computer per camera.

In exemplary embodiments of the present invention, after the image data is processed it is output to a plurality of panels which are simultaneously visible to a user. Each of the plurality of panels displays image data obtained from one of the plurality of image capture units. The image data is generally processed into a 360° user-controllable image file using a Social Animals 360° Flash player which wraps the footage into a 360° landscape. The 360° user-controllable image file permits a user to pan around, control the point of view, and perform functions such as play, pause, zoom, and clicking. The 360° user-controllable image file also includes clickable hotspots which launch additional functionality such as a new browser window, a new tab, or a Flash animation.

### BRIEF DESCRIPTION OF THE DRAWINGS

FIG. 1 shows an embodiment of the panoramic camera assembly;

FIG. 2 is a block diagram showing the components of the panoramic image capture and display system;

FIG. 3 is a flowchart showing the sequence of steps followed in obtaining and displaying panoramic images using the panoramic image capture and display system;

FIG. 4A is a schematic showing an object on a display screen and an off-screen object provided to the left of the on-screen object; and

FIG. 4B is a schematic showing an object on a display screen and an off-screen object provided to the right of the on-screen object.

### DETAILED DESCRIPTION OF THE INVENTION

These and other objectives of the invention will become more apparent from the following description and illustrative embodiments which are described in detail with reference to the accompanying drawings. Throughout the drawings, the same reference numerals and characters, unless otherwise stated, are used to denote like features, elements, components or portions of the illustrated embodiments.

The present invention provides a system and method of capturing and displaying cinema-quality 360° panoramic still and video images which are seamless and gapless across the entire 360° image and exhibit minimal warping and distortion. In one embodiment the system comprises a camera arrangement, housing assembly, post-production workflow, and display mechanism. The imaging system operates by acquiring a plurality of images, recording the images as image data, processing the images to produce seamless and continuous footage, and then packaging the images into an image file which can be viewed within a user-controllable viewing environment.

### I. Panoramic Image Capture System

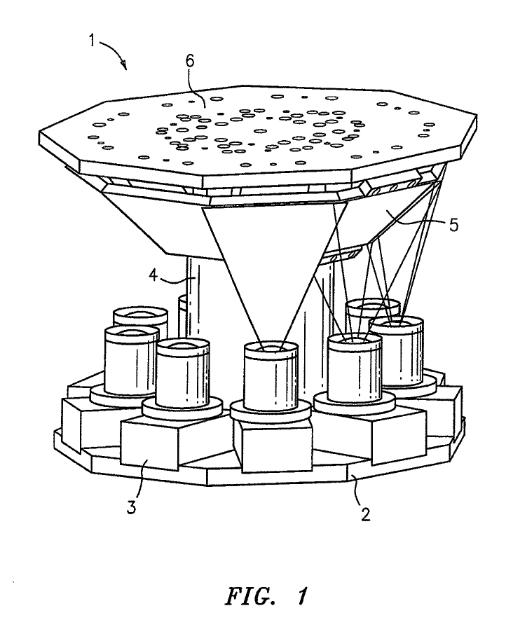

In one embodiment the images which will comprise the 360° landscape are obtained using a panoramic camera assembly 1, an example of which is provided in FIG. 1. The panoramic camera assembly 1 includes a base plate 2 which serves to support a plurality of cameras 3. The base plate 2 is typically a polygonal plate having a size and rigidity sufficient to support and secure the desired number of cameras 3 in specified locations. In the embodiment shown in FIG. 1, the panoramic camera assembly 1 is provided with a total of nine cameras 3 and, hence, the base plate 2 is a nine-sided polygon. A camera 3 is affixed to each side of the polygon such that the lens is pointed directly upwards, at a 90° angle to the plane of the base plate 2. The camera 3 used may be any type which is well-known in the art as long as it is capable of acquiring and transmitting images of the desired quality and at acceptable transmission speeds.

A cylindrical support 4 is provided in the center of the base plate and is of sufficient length and rigidity to support a plurality of reflecting mirrors 5 which are arranged about the outer periphery of the cylindrical support 4. The number of reflecting mirrors 5 used is identical to the number of cameras 3 provided on the base plate 2. In one embodiment, the reflecting mirrors 5 themselves are preferably aligned at an angle of 45° relative to the plane of the base plate 2. The mirror angle may, however, be varied to yield the desired optical configuration. The bottom of each reflecting mirror is affixed to the cylindrical support 4 whereas the top is attached to a top plate 6 which is provided at the upper end of the cylindrical support 4. In the embodiment provided in FIG. 1, the top plate 6 is also in the shape of a polygon, has the same number of sides as base plate 2, and is positioned such that each side of the top plate 6 and base plate 2 are aligned with each other. Each reflecting mirror 5 is substantially in the shape of an inverted trapezoid and is positioned such that its top edge is affixed to the top plate 6 and its bottom edge is attached to the cylindrical support 4. It is to be understood that although the base plate 2 and top plate 6 are shown and described in FIG. 1 as being polyhedrons having a total number of sides equal to the number of cameras/mirrors, the base plate 2 and top plate 6 can have essentially any shape. Their primary purpose is to provide a mechanical structure which is capable of supporting and aligning the cameras 3 and reflecting mirrors 5.

The optics of the panoramic camera assembly 1 are determined by the total number of cameras 3 and reflecting mirrors 5 used as well as their configuration within the supporting structure. For example, in FIG. 1, the imaging lens of each cameras 3 is situated at a predetermined radius Riens from the central axis of the panoramic camera assembly 1. Furthermore, the cameras 3 themselves are uniformly distributed about a circle of radius Riens. Since there are a total of nine cameras in the embodiment shown in FIG. 1, the cameras 3 are shown to be spaced 40° apart. The diameter of the cylindrical support 4 as well as the number, size, and position of the reflecting mirrors 5 is similarly determined by Riens and the total number of cameras used. Furthermore, each individual reflecting mirror 5 is aligned with the lens of a corresponding camera to permit imaging of each of their respective angular field of view.

During operation, the panoramic camera assembly 1 is typically affixed to some type of mechanical or pneumatic support which can be manipulated by a user such that the camera may be moved into the desired imaging position. During imaging operations, light rays from the scene to be imaged are reflected downwards by the reflecting mirrors 5 towards the lens of each individual camera 3. Since the cameras 3 are circumferentially arranged about the base plate 2, a 360° image may be obtained. Conventionally, some overlap between individual images obtained by each camera is provided to ensure that continuous and seamless 360° footage is captured. In this embodiment, the overlap between each individual image produces 405° of continuous footage around the panoramic camera assembly 1. Although the panoramic camera assembly 1 is shown and described as being supported and aligned vertically, it is to be understood that the camera itself may be used to acquire images at any orientation, including upside down, sideways, or any other configuration as is well-known in the art.

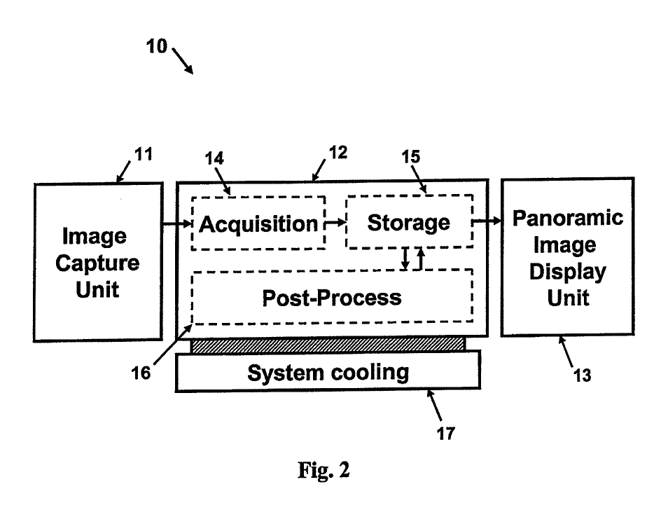

The panoramic camera assembly 1 is but one component of a panoramic image capture and display system 10, the components of all of which are illustrated in the block diagram provided in FIG. 2. The panoramic camera assembly 1 is one component of the image capture unit 11. The image capture unit 11 typically includes additional components such as a support frame, housing assembly, and connecting cables as is well-known in the art. In one embodiment the panoramic camera assembly 1 comprises nine SI-2k Mini digital cinema cameras outfitted with 12.5 mm lenses which are situated equi-distantly around a circle of radius RI.=8.5 inches. The camera lens each point upwards towards reflecting mirrors 5 which are aligned at 45° with respect to the vertical axis of the camera lens. This arrangement permits simultaneous capture of 405° of continuous footage which, after performing the appropriate image processing steps, yields 360° of motion with no gaps in coverage.

The output from each of the plurality of cameras 3 is delivered to at least one computing unit 12 per camera 3. The plurality of computing units 12 are, in turn, connected to a panoramic image display unit 13. A cooling unit 17 which houses and cools the computing unit(s) 12 is also provided. The cooling unit 17 is designed to house and cool the computing unit 12 and, if needed, the panoramic image display unit 13 which will be described in additional detail below. Each computing unit 12 typically consists of an acquisition unit 14, a storage unit 15, and a post-process unit 16 which together permit acquisition, storage, and processing of the image data received from each of the plurality of cameras 3.

In one embodiment the computing unit comprises at least one APPLE MACBOOK PRO laptop which is provided with the appropriate software to facilitate acquisition, storage, and processing of the images. In this embodiment, the Ethernet port, hard drive (internal or external) and CPU of the APPLE MACBOOK PRO® correspond to the acquisition 14, storage 15, and post-process 16 units, respectively. Although the computing unit is shown and described as an APPLE MACBOOK PRO® laptop, it is to be understood that substantially any computing unit can be used. The only requirement is that the computing unit be capable of acquiring, processing, and storing a large amount of image data in real time. In another embodiment a plurality of servers may be used. The computing unit(s) 12 are also connected to at least one panoramic image display unit 13 which permits viewing of the acquired images during image acquisition (e.g., in real time). In one embodiment the display unit 13 consists of a ten-panel monitor which permits the user to view all active camera angles simultaneously.

Once the desired footage has been captured it is necessary to process the images into a format which may be accessed by a viewer. The output after image processing is the product that the end-user actually sees and is able to manipulate using a custom image playback unit (not shown). In one embodiment the captured images are imported into a custom ADOBE AFTEREFFECTS CS4® template which brings the images together into a long, flat file in which each camera's footage is arranged side-by-side. This video is then placed into a Social Animals 360° Flash player which wraps the nine-frame (for nine cameras total), one-dimensional footage into a 360° landscape view. This is accomplished by seamlessly integrating image data from overlapping images. Additional or fewer cameras will yield more or less frames for inclusion in the file. The Social Animals 360° Flash player was produced using custom Flash code which allows a user to pan around the “room” produced by the wrapped landscape view, thereby controlling the point of view (POV) within the 360° content. The custom Flash code uses SiliconDVR, a proprietary interface design and the CineForm Raw Codec and toolset. Within the Social Animals 360° Flash player, the user is able to control the POV, the timeline, and to play, pause, zoom, and click on various hotspots provided within the 360° landscape. Clicking on a hotspot within the 360° landscape allows the user to launch a new browser window, create a new tab, or trigger Flash animations.

The panoramic image capture system 10 as described in this section is a fully digital 360° camera which is uniquely capable of providing seamless and gapless cinema-quality 360° coverage with minimal warping or distortion. The setup of the panoramic camera assembly 1 is such that no gaps are provided between each of the images acquired by adjacent cameras 3. Similarly, image quality is significantly enhanced through the use of digital image capture, processing, and storage. This dramatically changes the workflow and allows for conversion-free interactive online distribution. The use of digital technology also permits continuous image capture for extended periods of time. As an example, continuous shooting for two or more hours can be obtained without the need to swap storage devices such as, for example, the hard drive(s) used to store the acquired images. Another advantage is the compact size of the rig. A typical setup has a 17 inch by 17 inch cross-section and weighs less than 80 pounds. This permits use of the panoramic image capture system 10 in multiple new ways. As an example, the panoramic camera assembly can be mounted on the top of a vehicle which may be driven during image acquisition to continuously map geographical areas.

### II. Method of Acquiring and Displaying 360° Panoramic Images

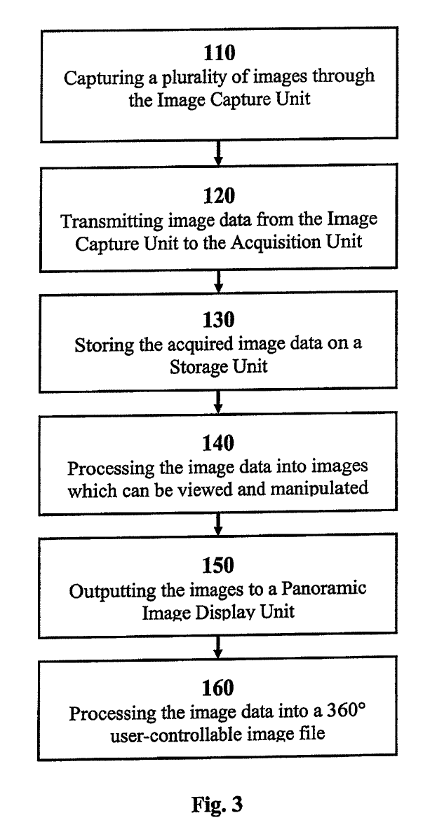

A method for acquiring, processing, and displaying panoramic 360° images which utilizes the panoramic image capture and display system 10 described in FIGS. 1-2 will now be described with reference to FIG. 3. FIG. 3 is a flowchart which shows the sequence of steps followed during image capture, processing, and display. Initially, in step 110 a plurality of images are captured using the image capture unit 11. This typically entails acquiring images using the panoramic camera assembly shown in FIG. 1. In step 120 the image data obtained from each camera 3 provided as part of the image capture unit 11 is transmitted to the computing unit 12 where it is received by the acquisition unit 14. The acquisition unit 14 in turn, stores the image data on a storage unit 15 in step 130.

While image data is continuously acquired and transmitted, in step 140 the post-process unit 16 processes the image data into actual photographic or video images which can be viewed and manipulated. In step 150 the images are output to the panoramic image display unit 13 where they may be observed by a viewer either during or after the actual steps of image acquisition. The final step 160 involves processing the thus-obtained image file into a user-controllable image file which may be viewed using, for example, a Social Animals 360° Flash player.

An exemplary method of displaying the acquired images in a manner which provides the illusion of a 360° panoramic image will now be described. The method involves initially loading a video file into the Flash player. A built-in Flash function is then used to copy the video pixels of the current frame into memory. Two separate objects which share the pixel data from memory are then created. These objects are placed next to each other on a display screen (e.g., a computer monitor) and are provided with code which watches the movement of the objects and switches the position of an object from one side of the display screen to another based on the location of the current on-screen object.

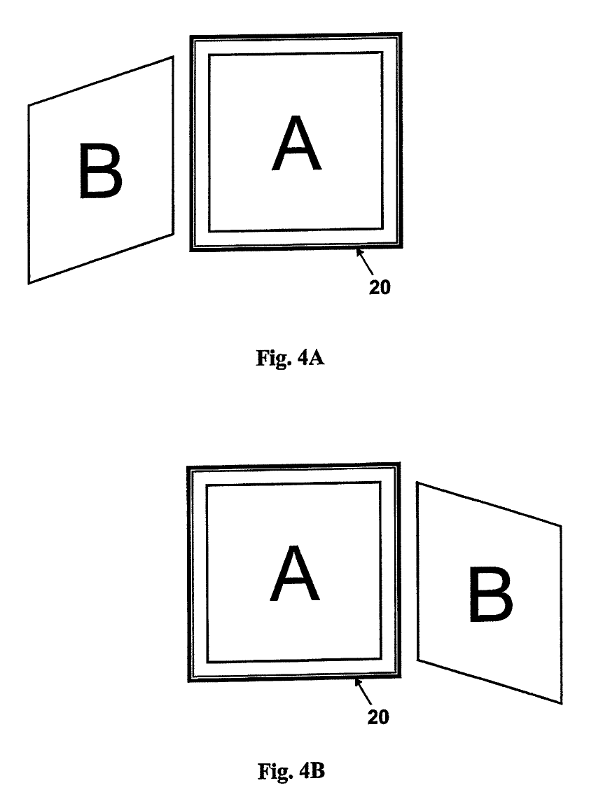

This process is best understood with reference to the examples provided in FIG. 4A-B. In this example a current object shown on the display screen is identified as “A” whereas a copy which is not currently visible on-screen is identified as “B” (i.e., it is off-screen). In FIGS. 4A-B, the display screen (20) shows object A as being currently on-screen where it is visible to a viewer whereas off-screen object B is shown to the left of A in FIG. 4A and off-screen object B is shown to the right of object A in FIG. 4B. When the left side of object A is close to the left edge of the display screen (20), object B is provided at the left as shown in FIG. 4A. However, when the right side of object A is close to the right edge of the screen (20), object B is provided at the right as shown in FIG. 4B. By continually cycling through objects to the left or right of the screen (20) based on whether the current on-screen objects closer to the left edge or the right edge, a seamless and gapless edge and the illusion of a 360° panoramic image is created.

A seamless and gapless edge is one where the transition from one image to another or an image itself is presented about the entire 360° view in smooth and continuous with substantially no discernible breaks or distortion of the images. Moreover, there is substantially no distortion in the continuity and replication of the image. Thus, the 360° panoramic image produced using the panoramic image display system and method disclosed in this specification appears as one continuous, cinematic quality image during viewing of both photographic and video images. Furthermore, the 360° image itself exhibits no warping or distortion across the entire viewing area of the image.

In still another embodiment, a method of moving through a video object based upon movement of a cursor is provided. This is accomplished by providing code which determines whether a user has clicked at a point on the screen. Once a click even has occurred, the location where the click happened is stored in memory. The distance between the original click location and the distance the mouse cursor has moved is continually measured and compared to the size of the player. The ratio between the distance the mouse has moved from the original click point and the size of the player is used to determine the speed for moving the video objects.

The panoramic camera assembly described in this specification is advantageous in that it allows for the acquisition of seamless and gapless 360° cinema-quality digital images. This permits a user to shoot high-quality images with minimal warping or distortion under substantially any imaging condition. These advantages are attainable because of improvements in imaging technology, raw computing power, and development of proprietary software which permits image acquisition, processing, and display as 360° panoramic image files. Another advantage is that the acquired images are output to an interactive flash player, enabling viewing and playback by essentially anyone with access to a computer or other, similar media player. This is a significant advantage over prior art systems which typically required large theatrical displays with a large circular projection apparatus.

It will be appreciated by persons skilled in the art that the present invention is not limited to what has been particularly shown and described in this specification. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are incorporated by reference as if fully set forth in this specification.

What is claimed is:

1. An apparatus for capturing and displaying panoramic images comprising:
a panoramic camera assembly comprising:
a base plate
a plurality of cameras whose lens are pointed along a vertical axis and are evenly distributed on the base plate about a circle of radius Riens;
a cylindrical support provided within the center of the base plate;
a plurality of reflecting mirrors, each of which is aligned with a corresponding camera and is positioned at a predetermined angle with respect to the vertical axis; and
a top plate;
at least one computing unit comprising:
an acquisition unit configured to receive image data from the panoramic camera assembly;
a storage unit configured to store image data acquired by the acquisition unit; and
a post-process unit configured to process the image data into a viewable format; and
a panoramic image display unit configured to display the image data,
wherein the displayed image data is seamless, gapless, and has substantially no warping or distortion.

2. The apparatus of claim 1 wherein a total of nine cameras are distributed 40° apart about the circle of radius Riens.

3. The apparatus of claim 2 wherein the cameras are SI-2k Mini digital cinema cameras.

4. The apparatus of claim 2 wherein Riens=8.5 inches.

5. The apparatus of claim 1 wherein the reflecting mirrors are positioned at a predetermined angle of 45°.

6. The apparatus of claim 1 wherein the computing unit consists of an APPLE MACBOOK PRO® laptop computer.

7. The apparatus of claim 1 wherein the acquisition unit is an Ethernet port.

8. The apparatus of claim 1 wherein the viewable format consists of a linear sequence of images which is wrapped to form a 360° panoramic image.

9. The apparatus of claim 8 wherein the viewable format is accessible using a Social Animals 360° Flash player.

10. The apparatus of claim 1 wherein the computing unit is contained within a cooling unit.

11. A method of capturing and displaying panoramic images comprising:
capturing image data from a plurality of images which together form a 360° panoramic view;
transmitting the image data to an acquisition unit;
storing the image data on a storage unit;
processing the image data into an imaging format capable of being viewed by a user;
outputting the images to a panoramic image display unit; and
processing the image data into a 360° user-controllable image file,
wherein the image data contained in the 360° user-controllable image file is seamless, gapless, and has substantially no warping or distortion.

12. The method of claim 11 wherein the image data is captured using a plurality of image capture units.

13. The method of claim 12 wherein the image capture units are SI-2k Mini digital cinema cameras.

14. The method of claim 11 wherein the image data is transmitted using an Ethernet port.

15. The method of claim 11 wherein the image data is processed using at least one APPLE MACBOOK PRO® laptop computer.

16. The method of claim 12 wherein the image data is output to a plurality of panels which are simultaneously visible.

17. The method of claim 16 wherein each of the plurality of panels displays image data obtained from one of the plurality of image capture units.

18. The method of claim 11 wherein the image data is processed into the 360° user-controllable image file using a Social Animals 360° Flash player which wraps the footage into a 360° landscape.

19. The method of claim 11 wherein the 360° user-controllable image file permits a user to pan around, control the point of view, and perform functions such as play, pause, zoom, and clicking.

20. The method of claim 11 wherein the 360° user-controllable image file includes clickable hotspots which launch additional functionality such as a new browser window, a new tab, or a Flash animation.
